(19) United States
(12) Patent Application Publication
(10) Pub. No.: US 2020/0095965 A1
(43) Pub. Date: Mar. 26, 2020

(54) RAPID ACTIVATION METHOD OF ELECTRICALLY CONTROLLED COMMON RAIL ENGINE

(71) Applicant: GUANGXI YUCHAI MACHINERY GROUP CO., LTD., Guangxi (CN)

(72) Inventors: Guirong TAN, Guangxi (CN); Zonghua MO, Guangxi (CN); Guoqiang HU, Guangxi (CN); Buwu SUN, Guangxi (CN); Jian ZHOU, Guangxi (CN); Junhong CHEN, Guangxi (CN); Zengliang ZHAO, Guangxi (CN); Huan LI, Guangxi (CN); Yangjun CAO, Guangxi (CN); Xueguang WANG, Guangxi (CN)

(73) Assignee: GUANGXI YUCHAI MACHINERY GROUP CO., LTD., Guangxi (CN)

(21) Appl. No.: 16/468,674

(22) PCT Filed: Oct. 23, 2017
(86) PCT No.: PCT/CN2017/106274

§ 371 Date: Jun. 11, 2019

(30) Foreign Application Priority Data
Feb. 17, 2017 (CN) 201710088317.9

(51) Int. Cl. F02M 37/54; F02M 37/00; F02M 37/20; F02M 55/00; F02N 19/00

(52) U.S. Cl. CPC F02M 37/54; F02M 37/0052; F02M 37/20; F02N 2019/002; F02N 19/001; F02M 2200/28; F02M 55/007

(57) ABSTRACT

A rapid activation method of an electrically controlled common ail engine. The method includes: arranging, between an oil outlet of a fuel transfer pump and an oil inlet of a fuel injection pump in the electrically controlled common rail engine, a gas discharging device; and communicating an outlet of the gas discharging device with a fuel tank via a pipe to discharge a gas present in fuel during a normal system operation. By arranging the gas discharging device at an oil feeding port of a fine filter, the method can be utilized to discharge, via the gas discharging device to the outside, air in the fine filter, thereby implementing active gas discharging, and effectively increasing activation performance of the engine.

### BACKGROUND OF THE INVENTION

### 1. Field of the Invention

The present invention relates to the field of engines, in particular, to a rapid activation method of an electrically controlled common rail engine.

### 2. Description of Related Art

In an existing electrically controlled common rail engine, a fuel system is an important factor affecting activation performance thereof. At present, an existing common rail system mainly improves the activation performance of an engine by optimizing system components and optimizing a complete machine layout design. However, these methods cannot completely solve the problem of long activation time or failure in activation. An electronic fuel transfer pump is added to some engines to speed up gas discharging of an oil channel, so a purpose of speeding up the activation can be achieved, and complete machine costs may be increased. Meanwhile, it is not recognized in the prior art that presence of gas from a fuel transfer pump to a fuel injection pump affects the activation performance.

### SUMMARY OF THE INVENTION

The present invention is directed to a rapid activation method of an electrically controlled common rail engine, which can effectively increase activation performance of the engine.

To this end, a rapid activation method of an electrically controlled common rail engine is provided. The method includes: arranging a gas discharging device between an oil outlet of a fuel transfer pump and an oil inlet of a fuel injection pump in the electrically controlled common rail engine; and communicating an outlet of the gas discharging device with a fuel tank via a pipe to discharge gas presenting in fuel during a normal system operation.

Preferably, a hole diameter of the outlet of the gas discharging device is preliminarily determined according to a following formula and determined by test verification:

$$d = 2 \sqrt{\frac{a}{π}} ; a = 2 PV / {v}^{2}$$

wherein P is a pressure in the fine filter, V is a volume of the fine filter, a is a cross-sectional area of the outlet of the gas discharging device, v is a flow velocity of fuel, and d is the hole diameter of the outlet of the gas discharging device.

Preferably, the gas discharging device is arranged at an oil feeding port of the fine filter.

Preferably, the gas discharging device is a small gas discharging hole.

Preferably, a hole diameter of the small gas discharging hole is between 0.2 mm and 3 mm.

Compared with the prior art, the present invention has the following beneficial effects:

In the present invention, by arranging the gas discharging device at the oil feeding port of the fine filter, air in the fine filter can be discharged via the gas discharging device, thereby implementing active gas discharging, and effectively increasing activation performance of the engine. Compared with a scheme adopting an electronic fuel transfer pump, the present invention is ingenious in structure and high in reliability, and effectively reduces the cost due to no additional control system. Compared with a scheme without an electronic fuel transfer pump, the present invention can significantly increase the activation speed of an engine.

### BRIEF DESCRIPTION OF THE DRAWINGS

FIG. 1 is a structural block diagram of the present invention.

FIG. 2 is a schematic structural view of the present invention.

FIG. 3 is a schematic structural view of a gas discharging device in the present invention.

FIG. 4 is a schematic view of a structural relationship between a fine filter and a gas discharging device in the present invention.

### DESCRIPTION OF THE EMBODIMENTS

The present invention is further described below with reference to embodiments, but does not constitute any limitation to the present invention, and any finite number of modifications made within the scope of the claims of the present invention are still within the scope of the claims of the present invention.

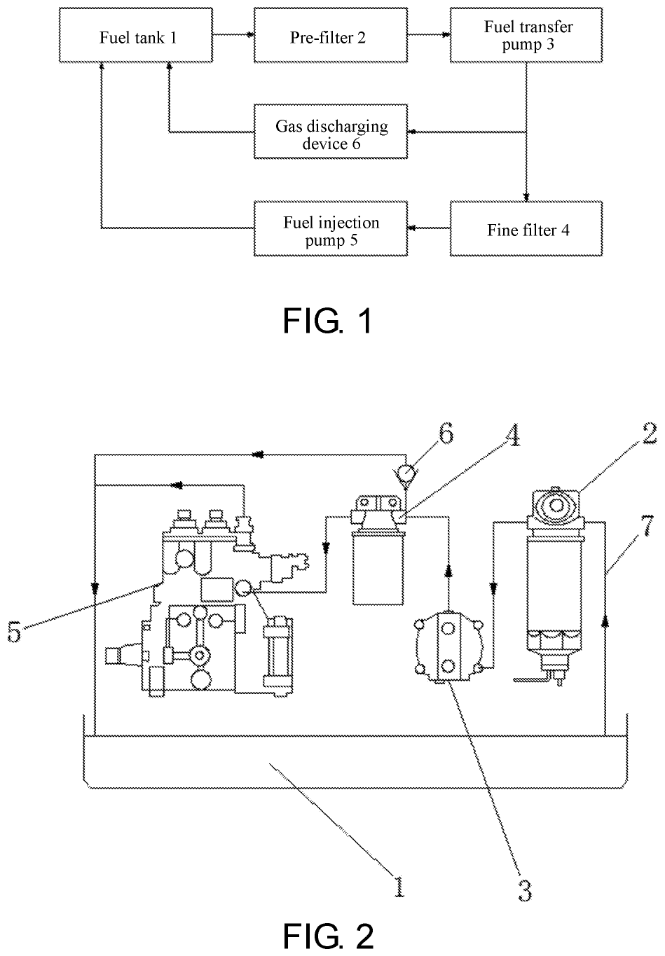

As shown in FIG. 1, the present invention provides a rapid activation method of an electrically controlled common rail engine. The method includes: arranging a gas discharging device 6 between an oil outlet of a fuel transfer pump 3 and an oil inlet of a fuel injection pump 5 in the electrically controlled common rail engine; and communicating an outlet of the gas discharging device 6 with a fuel tank 1 via a pipe to discharge a gas presenting in fuel during a normal system operation.

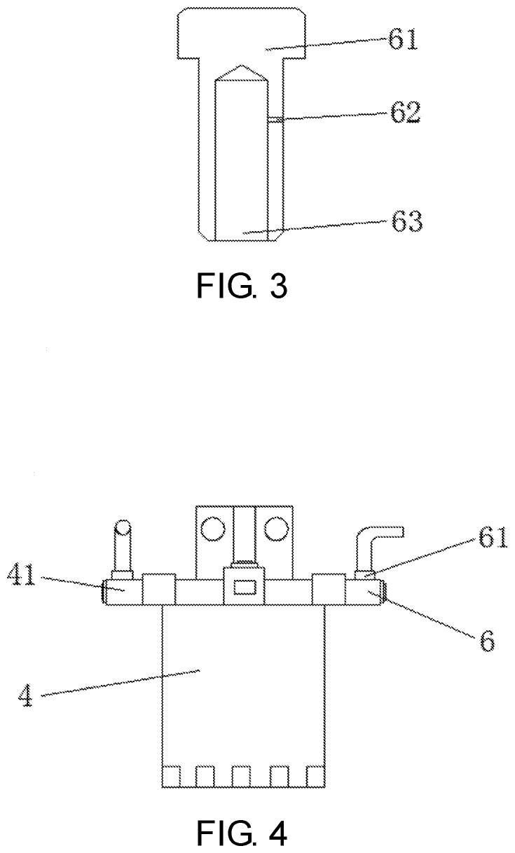

As shown in FIG. 3 and FIG. 4, a hole diameter of the outlet of the gas discharging device 6 is preliminarily determined according to a following formula and determined by test verification:

$$d = 2 \sqrt{\frac{a}{π}} ; a = 2 PV / {v}^{2}$$

wherein P is a pressure in a fine filter 4, V is a volume of the fine filter 4, a is a cross-sectional area of the outlet of the gas discharging device 6, v is a flow velocity of fuel, and d is the hole diameter of the outlet of the gas discharging device 6.

In the present embodiment, when calculating the hole diameter of a gas discharging hole 62, the hole diameter of the gas discharging hole 62 is preset according to the above formula with the experimental data before installing the gas discharging device 6, and the hole diameter of the gas discharging hole 62 is verified according to the above formula with the experimental data measured after installing the gas discharging device 6, so that the gas discharging device 6 can ensure sufficient gas discharging capability, and avoid excessive fuel flowing back to the fuel tank 1 via the gas discharging hole, thereby not affecting the normal operation of the engine.

As shown in FIG. 4, the gas discharging device 6 is arranged at an oil feeding port 41 of the fine filter 4, after the engine is activated to operate, when air enters the fine filter 4, the air may be discharged back into the fuel tank 1 through the gas discharging device 6 and an oil pipe 7, and meanwhile, by reasonably controlling the hole diameter of a small hole, the air in the fine filter 4 can be discharged without affecting the operation of the engine.

The method of the present invention can obviously and effectively shorten activation time of the electrically controlled common rail engine and can effectively increase activation performance of the engine.

As shown in FIG. 2 to FIG. 4, the present invention also provides a rapid activation system of an electrically controlled common rail engine. The system includes a fuel tank 1, a pre-filter 2, a fuel transfer pump 3, a fine filter 4, and a fuel injection pump 5. The fuel tank 1 is sequentially connected to the pre-filter 2, the fuel transfer pump 3, the fine filter 4, and the fuel injection pump 5 via an oil pipe 7. A fuel return port of the fuel injection pump 5 is also connected to the fuel tank 1 via the oil pipe 7. A gas discharging device 6 discharging a fuel gas is arranged between the fuel transfer pump 3 and the fine filter 4. An outlet of the gas discharging device 6 communicates with the fuel tank 1 via the oil pipe. A fixing mount 42 is arranged at an oil feeding port 41 of the fine filter 4. The gas discharging device 6 is fixed to the fine filter 4 via the fixing mount 42.

The gas discharging device 6 is an oil bolt with a small gas discharging hole. The gas discharging device 6 includes a housing 61, a housing inlet 63 provided at one end of the housing 61, and a gas discharging hole 62 provided on a side surface of the housing 61. The housing inlet 63 is connected to the fixing mount 42. The gas discharging hole 62 communicates with the fuel tank 1 via the oil pipe. The hole diameter of the gas discharging hole 62 is 0.5 mm.

In the present embodiment, the gas discharging device 6 and the fixing mount 42 are connected tightly through screw threads to fix the gas discharging device 6 to the fine filter 4. The influence of vibration of an engine during normal operation on the gas discharging device 6 can be effectively avoided. Normal service life of the gas discharging device 6 can be prolonged, and the stable operation performance can be increased.

In addition, the hole diameter of the gas discharging hole 62 may also be 0.2 mm or 0.7 mm or 1 mm or 1.5 mm or 2 mm or 3 mm.

An operation process of the present embodiment is as follows: after the engine is activated to operate, fuel in the fuel tank 1 sequentially passes through the pre-filter 2, the fuel transfer pump 3 and the fine filter 4 via the oil pipe 7 and is then injected to the fuel injection pump 5. When air enters the fine filter 4, the air may be discharged back into the fuel tank 1 through the gas discharging device 6, and meanwhile, by reasonably controlling the hole diameter of a small hole, the air in the fine filter 4 can be discharged without affecting the operation of the engine. Thus, the next activation time of the engine is shortened, and the purpose of smooth activation is achieved.

The effect contrast between the present invention and the existing activation system of an electrically controlled common rail engine is shown in Table 1.

TABLE 1

| | | | | | | | | Axial | |
|---|---|---|---|---|---|---|---|---|---|
| | | | Axial | Axial | | | Axial | pressure | |
| | Gas | start | pressure | pressure | | | pressure | setup to | successful |
| Number | discharging | drag | setup | closed | Ignition | Activation | setup to | closed | ignition |
| of tests | hole (mm) | (s) | start (s) | (s) | time (s) | time (s) | delay (s) | loop (s) | (s) |
| | 0 | 7.014 | 8.794 | 9.324 | 9.364 | 2.66 | 1.78 | 0.53 | 0.31 |
| 1 | 0.5 | 4.838 | 5.666 | 6.266 | 6.386 | 1.819 | 0.828 | 0.6 | 0.471 |
| 2 | 0.5 | 5.926 | 6.236 | 7.507 | 7.667 | 1.97 | 0.91 | 0.471 | 0.429 |

It can be seen from Table 1 that the activation time of the present invention is significantly and effectively shortened compared to the activation time of the existing electrically controlled common rail engine, thereby effectively increasing activation performance of the engine.

The above is only a preferred implementation of the present invention, and it should be noted that those skilled in the art can make various modifications and improvements without departing from the structure of the present invention, and such modifications and improvements do not affect the implementation effects and applicability of the present invention.

1. A rapid activation method of an electrically controlled common rail engine, comprising: arranging a gas discharging device between an oil outlet of a fuel transfer pump and an oil inlet of a fuel injection pump in the electrically controlled common rail engine; and communicating an outlet of the gas discharging device with a fuel tank via a pipe to discharge gas presenting in fuel during a normal system operation.

2. The rapid activation method of the electrically controlled common rail engine according to claim 1, wherein a hole diameter of the outlet of the gas discharging device is preliminarily determined according to a following formula and determined by test verification:
$$d = 2 \sqrt{\frac{a}{π}} ; a = 2 PV / {v}^{2}$$
wherein P is a pressure in a fine filter, V is a volume of the fine filter, a is a cross-sectional area of the outlet of the gas discharging device, v is a flow velocity of fuel, and d is the hole diameter of the outlet of the gas discharging device.

3. The rapid activation method of the electrically controlled common rail engine according to claim 1, wherein the gas discharging device is arranged at an oil feeding port of the fine filter.

4. The rapid activation method of the electrically controlled common rail engine according to claim 1, wherein the gas discharging device is a small gas discharging hole.

5. The rapid activation method of the electrically controlled common rail engine according to claim 4, wherein a hole diameter of the small gas discharging hole is between 0.2 mm and 3 mm.
